(19) United States
(12) Patent Application Publication
(10) Pub. No.: US 2019/0287100 A1
(43) Pub. Date: Sep. 19, 2019

(54) METHOD FOR MANAGING TOKEN BASED ON HETEROGENEOUS BLOCKCHAIN NETWORKS, AND TOKEN MANAGEMENT SERVER USING THE SAME

(71) Applicant: WAY2BIT Co. Ltd., Seongnam-si (KR)

(72) Inventors: Gyehan SONG, Seongnam-si (KR); Kyungho YUNE, Yongin-si (KR); Bongjun KIM, Hwaseong-si (KR)

(73) Assignee: WAY2BIT Co. Ltd., Seongnam-si (KR)

(21) Appl. No.: 16/299,174

(22) Filed: Mar. 12, 2019

(30) Foreign Application Priority Data
Mar. 13, 2018 (KR) 10-2018-0029456

(51) Int. Cl. G06Q 20/38; G06Q 20/06

(52) U.S. Cl. CPC G06Q 20/389; G06Q 2220/00; G06Q 20/381; G06Q 20/0658

(57) ABSTRACT

A method for token management of exchanging between a first cryptocurrency used by a first blockchain network and a second cryptocurrency used by a second blockchain network dependent on the first cryptocurrency is provided. The method includes steps of: a token-managing server (a) if a user's request for converting the first into the second cryptocurrencies is acquired, instructing the first blockchain network to transfer ownership of the first cryptocurrency to the token-managing server and issue the second cryptocurrency and instructing the second blockchain network to transfer ownership of the second cryptocurrency to the user; and (b) if a request of the user for converting the second into the first cryptocurrencies is acquired, instructing the second blockchain network to transfer ownership of the second cryptocurrency to the token-managing server and revocate the second cryptocurrency and instructing the first blockchain network to transfer ownership of the first cryptocurrency to the user.

### CROSS-REFERENCE TO RELATED APPLICATION

The present application claims priority to Korean Patent Application 10-2018-0029456, filed Mar. 13, 2018, the entire contents of which are incorporated herein by reference.

### FIELD OF THE DISCLOSURE

The present disclosure relates to a method for managing tokens based on heterogeneous blockchain networks; and more particularly, to the method for managing the tokens of an exchange between cryptocurrencies based on the heterogeneous blockchain networks, and the token management server using the same.

### BACKGROUND OF THE DISCLOSURE

In conventional industries, there has always been a problem of trust between a sender and a receiver of contents information. The reason for this is that it is difficult to prove and confirm whether or not facts were provided as they are, and that a transparent disclosure of the information has not been made, and that such information has always been mutable and prone to loss.

In particular, even when a content provider provides information in good-will, it is difficult for a user to confirm whether the information is true or not, and also difficult for the content provider to prove and convince a veracity of the information. For example, in an on-line poker game, it is difficult for a game player to acknowledge a fact that cards are shuffled randomly and distributed fairly. As another example, even if a fact that a random box awards a rare in-game item with a probability of 1% is provided, the user may not fully trust the fact and hesitate to purchase the random box.

In addition, providing the information as it is has not been done properly. In other words, the content provider itself who owns a server and a DB can control logging, storing, and disclosing of the information, and this fact makes it difficult for users to know what information is recorded and which level or part of the information is disclosed. For example, most on-line poker games, except for some services mandated by law, do not provide information on a progress of each game and a handling of results (hand history), and most mobile games do not provide individual probabilities and expectation values for probabilistic products that are sold through in-app purchases.

In addition, this information stored in the DB may be modified or tampered with by mistakes or on purpose on the content provider's side or by a bug, and sometimes lost or not even recorded without a trace, and this mutability has had a bad influence on a credibility of services.

And these problems cause a lot of unnecessary costs. For example, most of customer inquiries for the on-line poker games are related to “suspicion of a hand manipulation and distrust of game record” or “game money lost or stolen”, and in many cases, a separate customer service organization and a large-scale workforce have been adopted to handle the inquiries.

In addition, the content provider produces or distributes contents such as games, communities, gambling, entertainment, etc., and at the same time provides various services related thereto, and the users enjoy and consume the contents through time investment, participation, effort, engagement, payment, etc. As a result, the content provider gains direct revenue or profit sources, and the users get emotion, experience, and digital assets. Even though mutual values are obtained through such trades, much of the user's digital assets cannot be entirely theirs. This is because most of the user's digital assets depend on the service of the content provider.

For example, “100 million game money” earned by the user, “Platinum reputation rating” earned through the community activity, and “Army of 100,000” achieved with time and money, are lost if the services stop, regardless of how much time, effort, and money are spent on them. This dependence of user assets on external sources, that is, a part that makes the users think they have no control over their assets, lowers degrees of participation, engagement, and payment of the users, and the content providers are forced to pay more effort and money to find more loyal users.

In addition, because of a relationship between the users and the content providers in the form of ‘one-to-many’, the assets accumulated in each of different services cannot be integrated into one nor can be measured on a consistent basis. In other words, assets that cannot be appraised are hardly subject to ownership, exchange, and trades, and as a result, a relatively small number of the users are willing to pay their money and efforts to obtain such assets.

For this reason, the content providers of the games etc. have to spend a lot of money and compete fiercely to increase their users' purchase conversion rates as much as possible within their business models based on the in-app purchases or freemium.

Also, values of the assets of the content service can be easily damaged or lost. For example, 100 million blackjack game money the users have earned over the years of playing can be reduced to a value of 1/100 as a result of game money duplication caused by hacking or abusing. One day, the value of the game money could plummet as blackjack game providers aggressively offer 100 million game money every day to attract new users.

As such, the user's digital assets, that rely on the content providers, that are difficult to integrate, and that can be lost at any time, are difficult to have any value. Apparently, value-based exchange and trading activities are difficult to arrange. This lowers the user's motivation for participation and quality of the participation. As a result, the cost of securing the loyal users becomes high, and the increased cost can result in a vicious cycle in which service quality is deteriorating.

In addition, the values of the digital assets of some content services are recognized in a course of exchange or trade through brokering. For example, in a mobile RPG game, an intermediary transaction can be made where in-game money (e.g., gold) may be bought from a user and sold at a lower price than in-game stores. In a case of a game service in which in-game money transactions are popular, there are professional brokers who purchase the in-game money from the users and resell it. They usually buy the in-game money at 80% of in-game store price and resell it at 90%, taking 10% to 15% of profits, and their estimated transaction volume is often larger than the revenue generated within the game service.

However, fraud and excessive commissions fees in brokering increased transaction risk and costs and lowered transaction quality. Some malicious brokers steal the in-game money through hacking and resell it at cheap prices. In order to solve this problem, item trading sites have appeared, but the fraud still occurs between the buyer and the seller, transaction procedures are complicated, and the commission fee is not cheap.

In particular, Internet-based commercial content services such as games and communities require massive and rapid transaction processing.

Therefore, recently, there have been many content providers who try to provide a blockchain-based application service, which is a decentralized application platform, to prevent forgery and alteration of provided data and to facilitate rapid transaction processing and reliability of information.

In particular, many content providers are planning decentralized wallets and paying solutions instead of traditional payment modules and credit cards in introducing blockchain technology.

However, when a content service such as the game is provided using cryptocurrency based on the conventional blockchain technology, the users are burdened with high commission fees.

For example, if frequent transactions occur at a fixed commission fee where the commission fee is charged for each transaction, the cost the user has to pay for will increase, and an amount of the cryptocurrency consumed by the transaction fee rather than by content usage will increase.

### SUMMARY OF THE DISCLOSURE

It is an object of the present disclosure to solve all the aforementioned problems.

It is another object of the present disclosure to provide a method and a server for guaranteeing contents and values of digital assets of a user acquired while using a content service.

It is still another object of the present disclosure to provide the method and the server for reducing risk or cost of a transaction of the digital assets of the user in digital contents.

It is still yet another object of the present disclosure to provide the method and the server for guaranteeing security and transparency of execution and logging of the transaction in the digital contents.

In accordance with one aspect of the present disclosure, there is provided a method for token management of an exchange between a first cryptocurrency and a second cryptocurrency, wherein a first blockchain network uses the first cryptocurrency and a second blockchain network uses the second cryptocurrency which is dependent on the first cryptocurrency, including steps of: (a) a token-managing server, if an exchange request, of a specific user who owns at least a specific part of the first cryptocurrency which is an amount of the first cryptocurrency requested for conversion, for converting from the first cryptocurrency to the second cryptocurrency is acquired, instructing the first blockchain network to transfer an ownership of the specific part of the first cryptocurrency, from the specific user to the token-managing server and issue a specific part of the second cryptocurrency corresponding to the specific part of the first cryptocurrency and instructing the second blockchain network to transfer an ownership of the issued specific part of the second cryptocurrency from the token-managing server to the specific user; and (b) the token-managing server, if an exchange request, of the specific user who owns at least a particular part of the second cryptocurrency which is an amount of the second cryptocurrency requested for conversion, for converting from the second cryptocurrency to the first cryptocurrency is acquired, instructing the second blockchain network to transfer an ownership of the particular part of the second cryptocurrency from the specific user to the token-managing server and revocate the particular part of the second cryptocurrency and instructing the first blockchain network to transfer an ownership of a particular part of the first cryptocurrency corresponding to the revocated particular part of the second cryptocurrency from the token-managing server to the specific user.

As one example, if the second blockchain network is determined as including each of sub-blockchain networks corresponding to each of service servers providing each of services to general users including the specific user by using the second cryptocurrency, the token-managing server monitors transactions, related to the second cryptocurrency, generated in each of the sub-blockchain networks and monitors information on the second cryptocurrency, corresponding to the general users, over all of the sub-blockchain networks.

As one example, the token-managing server allows the second cryptocurrency to have different units of values in each of the sub-blockchain networks.

As one example, the token-managing server allows an exchange rate between (i) the first cryptocurrency having a market value and (ii) the second cryptocurrency to be either fixed at a preset exchange rate or free-floating according to the market value.

As one example, the token-managing server confirms one or more exchange requests for converting from the specific part of the first cryptocurrency to the specific part of the second cryptocurrency made by the specific user or one or more exchange requests for converting from the particular part of the second cryptocurrency to the particular part of the first cryptocurrency made by the specific user, and determines whether any of the exchange requests violates at least one preset rule.

As one example, the token-managing server manages at least one exchange rule and at least one exchange-rate generating rule between the first cryptocurrency and the second cryptocurrency.

As one example, the token-managing server determines at least one of (i) an exchange-rate function between the first cryptocurrency and the second cryptocurrency, (ii) an amount requestable per transaction corresponding to the exchange request, (iii) an amount requestable per user, (iv) an amount requestable during a specific period and the number of exchange requests allowed during the specific period, (v) an exchange-rate policy, (vi) an exchange commission-fee policy for a preset commission fee incurred by the conversion from the second cryptocurrency to the first cryptocurrency, (vii) a calculation policy for calculating a point in time of executing any conversion between the first cryptocurrency and the second cryptocurrency compared to a point in time of the exchange request, and (viii) a limiting policy on a total requested amount and on withdrawal per a total circulation of the second cryptocurrency.

As one example, at the step of (b), the token-managing server (i) subtracts a preset commission fee from the particular part of the second cryptocurrency, in response to the exchange request for converting from the particular part of the second cryptocurrency to the particular part of the first cryptocurrency, (ii) revocates an adjusted particular part of the second cryptocurrency representing an amount of the second cryptocurrency acquired by subtracting the preset commission fee from the particular second part of the second cryptocurrency, and (iii) instructs the first blockchain network to transfer an ownership of an adjusted particular part of the first cryptocurrency, corresponding to the adjusted particular part of the second cryptocurrency, from the token-managing server to the specific user.

As one example, the token-managing server collects a certain part of the second cryptocurrency corresponding to commission fees, including the preset commission fee, from a first part of general users including the specific user into an incentive fund under an ownership of the token-managing server, to thereby manage the incentive fund, and either distributes the certain part of the second cryptocurrency in the incentive fund to a second part of the general users by referring to degrees of contribution of the second part of the general users, or converts from the certain part of the second cryptocurrency to a certain part of the first cryptocurrency, to thereby distribute the certain part of the first cryptocurrency to owners of the certain part of the first cryptocurrency by referring to the degrees of contribution of the second part of the general users.

In accordance with another aspect of the present disclosure, there is provided a method for token management of an exchange between a first cryptocurrency and a second cryptocurrency, wherein a public blockchain network uses the first cryptocurrency having a market value and wherein a private blockchain network is connected with each of service servers providing each of services to at least one specific user by using the second cryptocurrency which is dependent on the first cryptocurrency, including steps of: (a) a token-managing server, if an exchange request, of the specific user who owns at least a specific part of the first cryptocurrency which is an amount of the first cryptocurrency requested for conversion, for converting from the first cryptocurrency to the second cryptocurrency is acquired, instructing the public blockchain network to transfer an ownership of the specific part of the first cryptocurrency, from the specific user to the token-managing server and issue a specific part of the second cryptocurrency corresponding to the specific part of the first cryptocurrency and instructing at least part of the private blockchain network to transfer an ownership of the issued specific part of the second cryptocurrency from the token-managing server to the specific user, to thereby allow the specific user to use each of the services provided by the service servers in connection with at least part of the private blockchain network by using the issued specific part of the second cryptocurrency; and (b) the token-managing server, if an exchange request, of the specific user who owns at least a particular part of the second cryptocurrency which is an amount of the second cryptocurrency requested for conversion, for converting from the second cryptocurrency to the first cryptocurrency is acquired, instructing at least part of the private blockchain network to transfer an ownership of the particular part of the second cryptocurrency from the specific user to the token-managing server and revocate the particular part of the second cryptocurrency and instructing the public blockchain network to transfer an ownership of a particular part of the first cryptocurrency corresponding to the revocated particular part of the second cryptocurrency from the token-managing server to the specific user.

In accordance with still another aspect of the present disclosure, there is provided a token-managing server for token management of an exchange between a first cryptocurrency and a second cryptocurrency, wherein a first blockchain network uses the first cryptocurrency and a second blockchain network uses the second cryptocurrency which is dependent on the first cryptocurrency, including: at least one memory that stores instructions; and at least one processor configured to execute the instructions to perform or support another device to perform processes of: (I) if an exchange request, of a specific user who owns at least a specific part of the first cryptocurrency which is an amount of the first cryptocurrency requested for conversion, for converting from the first cryptocurrency to the second cryptocurrency is acquired, instructing the first blockchain network to transfer an ownership of the specific part of the first cryptocurrency, from the specific user to the token-managing server and issue a specific part of the second cryptocurrency corresponding to the specific part of the first cryptocurrency and instructing the second blockchain network to transfer an ownership of the issued specific part of the second cryptocurrency from the token-managing server to the specific user, and (II) if an exchange request, of the specific user who owns at least a particular part of the second cryptocurrency which is an amount of the second cryptocurrency requested for conversion, for converting from the second cryptocurrency to the first cryptocurrency is acquired, instructing the second blockchain network to transfer an ownership of the particular part of the second cryptocurrency from the specific user to the token-managing server and revocate the particular part of the second cryptocurrency and instructing the first blockchain network to transfer an ownership of a particular part of the first cryptocurrency corresponding to the revocated particular part of the second cryptocurrency from the token-managing server to the specific user.

As one example, if the second blockchain network is determined as including each of sub-blockchain networks corresponding to each of service servers providing each of services to general users including the specific user by using the second cryptocurrency, the processor monitors transactions, related to the second cryptocurrency, generated in each of the sub-blockchain networks and monitors information on the second cryptocurrency, corresponding to the general users, over all of the sub-blockchain networks.

As one example, the processor allows the second cryptocurrency to have different units of values in each of the sub-blockchain networks.

As one example, the processor allows an exchange rate between (i) the first cryptocurrency having a market value and (ii) the second cryptocurrency to be either fixed at a preset exchange rate or free-floating according to the market value.

As one example, the processor confirms one or more exchange requests for converting from the specific part of the first cryptocurrency to the specific part of the second cryptocurrency made by the specific user or one or more exchange requests for converting from the particular part of the second cryptocurrency to the particular part of the first cryptocurrency made by the specific user, and determines whether any of the exchange requests violates at least one preset rule.

As one example, the processor manages at least one exchange rule and at least one exchange-rate generating rule between the first cryptocurrency and the second cryptocurrency.

As one example, the processor determines at least one of (i) an exchange-rate function between the first cryptocurrency and the second cryptocurrency, (ii) an amount requestable per transaction corresponding to the exchange request, (iii) an amount requestable per user, (iv) an amount requestable during a specific period and the number of exchange requests allowed during the specific period, (v) an exchange-rate policy, (vi) an exchange commission-fee policy for a preset commission fee incurred by the conversion from the second cryptocurrency to the first cryptocurrency, (vii) a calculation policy for calculating a point in time of executing any conversion between the first cryptocurrency and the second cryptocurrency compared to a point in time of the exchange request, and (viii) a limiting policy on a total requested amount and on withdrawal per a total circulation of the second cryptocurrency.

As one example, at the process of (II), the processor (i) subtracts a preset commission fee from the particular part of the second cryptocurrency, in response to the exchange request for converting from the particular part of the second cryptocurrency to the particular part of the first cryptocurrency, (ii) revocates an adjusted particular part of the second cryptocurrency representing an amount of the second cryptocurrency acquired by subtracting the preset commission fee from the particular second part of the second cryptocurrency, and (iii) instructs the first blockchain network to transfer an ownership of an adjusted particular part of the first cryptocurrency, corresponding to the adjusted particular part of the second cryptocurrency, from the token-managing server to the specific user.

As one example, the processor collects a certain part of the second cryptocurrency corresponding to commission fees, including the preset commission fee, from a first part of general users including the specific user into an incentive fund under an ownership of the token-managing server, to thereby manage the incentive fund, and either distributes the certain part of the second cryptocurrency in the incentive fund to a second part of the general users by referring to degrees of contribution of the second part of the general users, or converts from the certain part of the second cryptocurrency to a certain part of the first cryptocurrency, to thereby distribute the certain part of the first cryptocurrency to owners of the certain part of the first cryptocurrency by referring to the degrees of contribution of the second part of the general users.

In accordance with still yet another aspect of the present disclosure, there is provided a token-managing server for token management of an exchange between a first cryptocurrency and a second cryptocurrency, wherein a public blockchain network uses the first cryptocurrency having a market value and wherein a private blockchain network is connected with each of service servers providing each of services to at least one specific user by using the second cryptocurrency which is dependent on the first cryptocurrency, including: at least one memory that stores instructions; and at least one processor configured to execute the instructions to perform or support another device to perform processes of: (I) if an exchange request, of the specific user who owns at least a specific part of the first cryptocurrency which is an amount of the first cryptocurrency requested for conversion, for converting from the first cryptocurrency to the second cryptocurrency is acquired, instructing the public blockchain network to transfer an ownership of the specific part of the first cryptocurrency, from the specific user to the token-managing server and issue a specific part of the second cryptocurrency corresponding to the specific part of the first cryptocurrency and instructing at least part of the private blockchain network to transfer an ownership of the issued specific part of the second cryptocurrency from the token-managing server to the specific user, to thereby allow the specific user to use each of the services provided by the service servers in connection with at least part of the private blockchain network by using the issued specific part of the second cryptocurrency, and (II) if an exchange request, of the specific user who owns at least a particular part of the second cryptocurrency which is an amount of the second cryptocurrency requested for conversion, for converting from the second cryptocurrency to the first cryptocurrency is acquired, instructing at least part of the private blockchain network to transfer an ownership of the particular part of the second cryptocurrency from the specific user to the token-managing server and revocate the particular part of the second cryptocurrency and instructing the public blockchain network to transfer an ownership of a particular part of the first cryptocurrency corresponding to the revocated particular part of the second cryptocurrency from the token-managing server to the specific user.

Further, in accordance with one example embodiment of the present disclosure, a token-managing server for performing methods mentioned above is provided.

In addition, recordable media that are readable by a computer for storing a computer program to execute the method of the present disclosure is further provided.

### BRIEF DESCRIPTION OF THE DRAWINGS

The above and other objects and features of the present disclosure will become apparent from the following description of preferred embodiments given in conjunction with the accompanying drawings, in which:

FIG. 1 is a drawing schematically illustrating a blockchain ecosystem including a token-managing server based on heterogeneous blockchain networks in accordance with one example embodiment of the present disclosure.

FIG. 2 is a drawing schematically illustrating a platform of the blockchain ecosystem including the token-managing server based on the heterogeneous blockchain networks in accordance with one example embodiment of the present disclosure.

FIG. 3 is a drawing schematically illustrating an exemplar process of a token management based on the heterogeneous blockchain networks in accordance with one example embodiment of the present disclosure.

FIG. 4 is a drawing schematically illustrating a process of using a cryptocurrency in the method of the token management based on the heterogeneous blockchain networks in accordance with one example embodiment of the present disclosure.

FIG. 5 is a drawing schematically illustrating another exemplar process of the token management based on the heterogeneous blockchain networks in accordance with one example embodiment of the present disclosure.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

Identical reference numerals are for convenience of explanation but not intended for representing sameness of separate devices.

Throughout the present disclosure, every processor, every memory, every storage, or any other computing components are described as separate components, however, said every processor, said every memory, said every storage, or said any other computing components may be configured as a single device or any other combinations thereof.

To allow those skilled in the art to the present disclosure to be carried out easily, the example embodiments of the present disclosure by referring to attached diagrams will be explained in detail as shown below.

The present specification discloses a first blockchain network 300 and a second blockchain network 100. For example, the first blockchain network 300 may be a public blockchain and the second blockchain network 100 may be a private blockchain, but the scope of the present disclosure is not limited thereto.

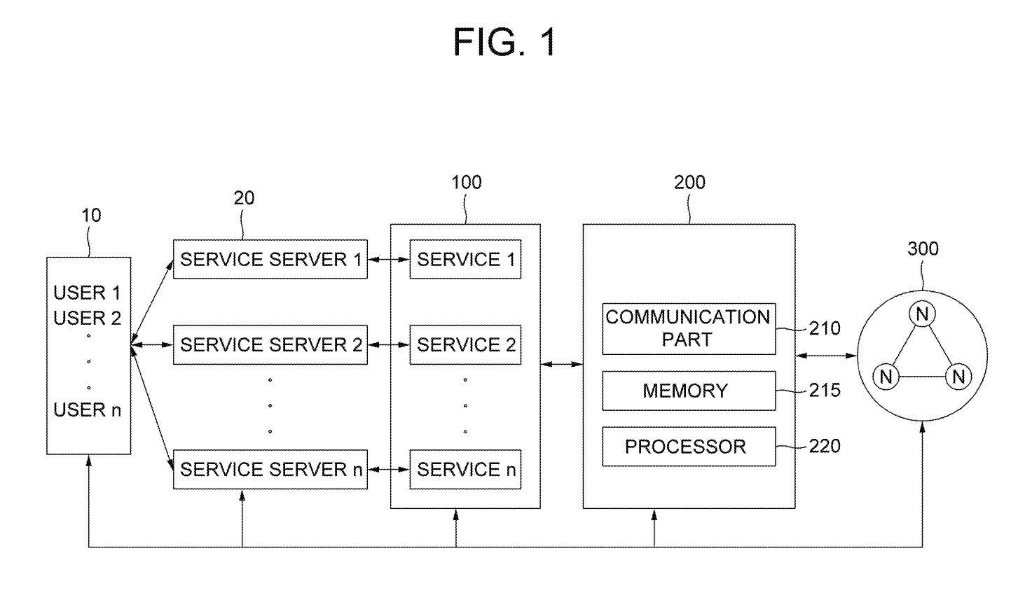

FIG. 1 is a drawing schematically illustrating a blockchain ecosystem including a token-managing server based on heterogeneous blockchain networks in accordance with one example embodiment of the present disclosure, and the blockchain ecosystem may include the second blockchain network 100 and the token-managing server 200.

First, the second blockchain network 100 may use a second cryptocurrency which is dependent on a first cryptocurrency used by the first blockchain network 300, may communicate with service servers 20 providing each of services to users 10, and may record transactions handled by each of the service servers 20 by using distributed ledger technology or perform actions according to the transactions.

Herein, the second blockchain network 100 may include each of sub-blockchain networks, represented as service 1, service 2, . . . , and service n, corresponding to each of the service servers 20 providing each of the services, by using the second cryptocurrency, to the users 10. Also, as aforementioned, the second blockchain network 100 may be configured as the private blockchain.

Next, the token-managing server 200 may perform at least one exchange between the first cryptocurrency and the second cryptocurrency, where the first blockchain network 300 may use the first cryptocurrency and the second blockchain network 100 may use the second cryptocurrency which is dependent on the first cryptocurrency, and may include a communication part 210, a memory 215 for storing instructions to exchange between the first cryptocurrency and the second cryptocurrency, and a processor 220 for performing processes corresponding to the instructions in the memory to exchange between the first cryptocurrency and the second cryptocurrency. Further, according to another example embodiment of the present disclosure, the method may be performed by the token-managing server 200 or another server of a different configuration. For example, the token-managing server 200 may be a server corresponding to one of nodes in the second blockchain network 100, or may be a server managing each of the nodes in the second blockchain network 100, or may be a transaction server. In addition to this, the token-managing server 200 may be a server same as a server forming the second blockchain network 100, and may be an application logically running in the server.

The token-managing server 200 may typically achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

The communication part 210 of such devices may transmit requests to and receive responses from other linked devices. As one example, such requests and responses may be carried out by the same TCP session, but the scope of the present invention is not limited thereto. For example, they could be transmitted and received as UDP datagrams.

The processor 220 of such devices may include hardware configuration of MPU (Micro Processing Unit) or CPU (Central Processing Unit), cache memory, data bus, etc. Additionally, any OS and software configuration of applications that achieve specific purposes may be further included.

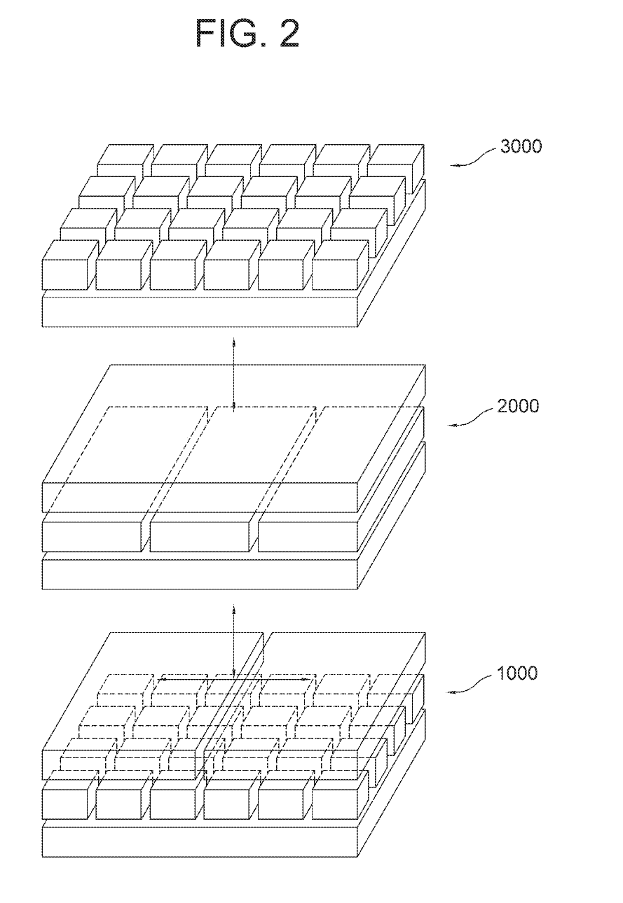

FIG. 2 is a drawing schematically illustrating a platform of the blockchain ecosystem including the token-managing server based on the heterogeneous blockchain networks in accordance with one example embodiment of the present disclosure.

By referring to FIG. 2, the platform may include a core layer 1000, a service layer 2000, and an application layer 3000.

The core layer 1000 may include an infra and a data network, the second blockchain network 100 may be located over the infra and the data network, and the token-managing server 200 may be located over the second blockchain network 100.

And, the service layer 2000 may include at least one API and at least one SDK, identification and operation tools, etc. may be located over the API and the SDK, and at least one policy of the platform may be located over the identification and operation tools, etc.

And, in the application layer 3000, applications or web services of content providers may be located over applications or web services of the second blockchain network 100.

As a result, each of the content providers may implement its own independent blockchain network, and may provide secure service environment by guaranteeing data and transaction independent of other service providers, i.e., other blockchain networks, within the platform.

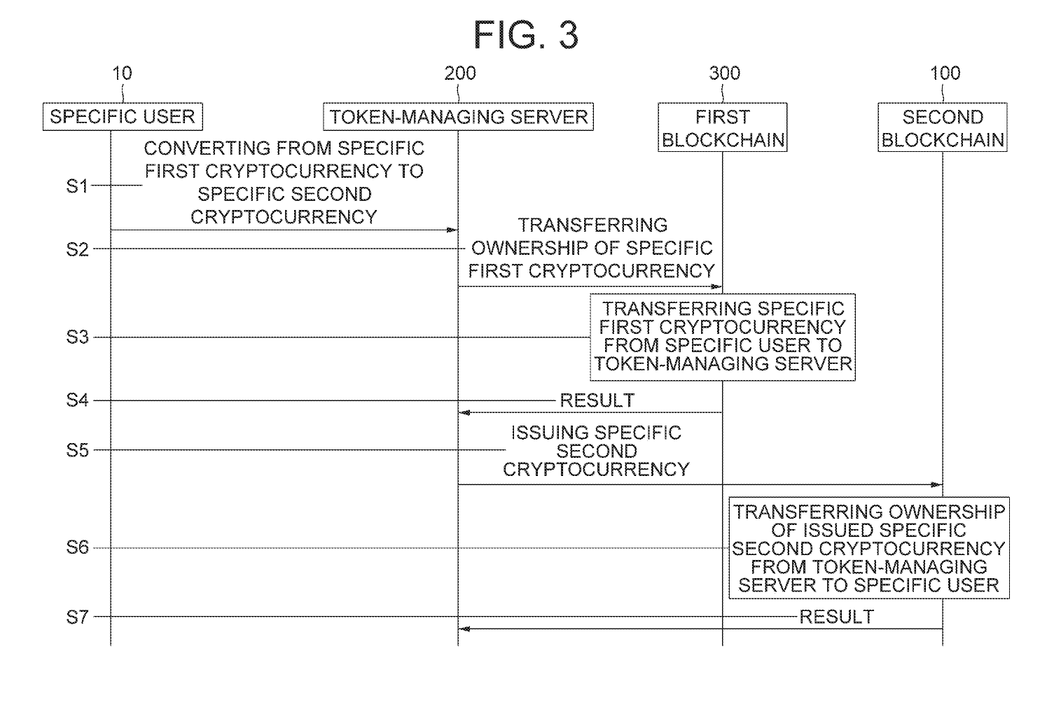

A method for a token management by using the blockchain ecosystem including the token-managing server based on the heterogeneous blockchain networks configured as such in accordance with one example of the present disclosure, that is, the method for the token management of exchanging between the first cryptocurrency and the second cryptocurrency, where the first blockchain network 300 uses the first cryptocurrency and the second blockchain network 100 uses the second cryptocurrency dependent on the first cryptocurrency, is explained by referring to FIGS. 3 to 5.

First, by referring to FIG. 3, a method of converting from the first cryptocurrency to the second cryptocurrency, i.e., a method of exchanging the first cryptocurrency with the second cryptocurrency, is disclosed.

A specific user may transmit an exchange request for converting from a specific part of the first cryptocurrency, which is an amount of the first cryptocurrency requested for conversion, to a specific part of the second cryptocurrency corresponding to the specific part of the first cryptocurrency by way of a user device at a step of S1 by using at least a specific part, owned by the specific user, of the first cryptocurrency circulating in a cryptocurrency market, to obtain the second cryptocurrency for use of services like games, community services, etc. provided by the service servers 20 communicating with the second blockchain network 100. Herein, the user device may include a PC (Personal Computer), a mobile computer, a PDA/EDA, a mobile phone, a smart phone, a tablet, an IoT device, etc. And, the user device is not limited thereto, and may include any mobile device like a digital camera, a personal navigation device, and a mobile gaming device, etc. capable of wired and wireless communication. In addition, the user device may include a communication part and a processor.

Then, the token-managing server 200 may instruct the first blockchain network 300 to transfer an ownership of the specific part of the first cryptocurrency from the specific user 10 to the token-managing server 200.

As one example, in response to the exchange request for converting from the specific part of the first cryptocurrency to the specific part of the second cryptocurrency acquired by the communication part 210, the token-managing server 200 may transmit a request for transferring the ownership of the specific part of the first cryptocurrency from the specific user 10 to the token-managing server 200, or may instruct the specific user 10 to transfer the specific part of the first cryptocurrency to the token-managing server 200, at a step of S2. Then, in response to a transaction, related to the transfer of the specific part of the first cryptocurrency, created by the token-managing server 200 or the specific user 10, the first blockchain network 300 may transfer the specific part of the first cryptocurrency to the token-managing server 200 at a step of S3, and may transmit a result of the transfer to at least part of the specific user 10 and the token-managing server 200 at a step of S4. That is, the ownership of the specific part of the first cryptocurrency may be transferred from the specific user 10 to the token-managing server 200, as requested by the specific user, on the first blockchain network 300.

Also, the token-managing server 200 may issue a specific part of the second cryptocurrency corresponding to the specific part of the first cryptocurrency and may instruct the second blockchain network 100 to transfer an ownership of the issued specific part of the second cryptocurrency from the token-managing server 200 to the specific user 10.

As one example, the token-managing server 200 may transmit a request for issuing the specific part of the second cryptocurrency to the second blockchain network 100 at a step of S5. Then, the second blockchain network 100 may issue the specific part of the second cryptocurrency requested by the token-managing server 200 such that the token-managing server 200 owns the issued specific part of the second cryptocurrency, and then may allow an ownership of the issued specific part of the second cryptocurrency to be transferred from the token-managing server 200 to the specific user 10, at a step of S6, and may transmit a result of the transfer to at least part of the specific user 10 and the token-managing server 200 at a step of S7.

Herein, as can be seen in FIG. 1, the second blockchain network 100 may include each of the sub-blockchain networks, represented as service 1, service 2, . . . , and service n, corresponding to each of the service servers 20 providing each of the services to general users including the specific user by using the second cryptocurrency, and in this case, the token-managing server 200 may monitor transactions, related to the second cryptocurrency, generated in each of the sub-blockchain networks and may monitor information on the second cryptocurrency, corresponding to the general users, over all of the sub-blockchain networks.

That is, each of the general users may use the services provided by each of the service servers 20 by using the second cryptocurrency, and the token-managing server 200 may monitor details of the second cryptocurrency used in each of the services by each of the general users and may monitor information on final ownership of the second cryptocurrency by the general users using the services.

Also, if the second blockchain network 100 includes each of the sub-blockchain networks service 1, service 2, . . . , and service n, then the token-managing server 200 may allow the second cryptocurrency to have different units of values in each of the sub-blockchain networks.

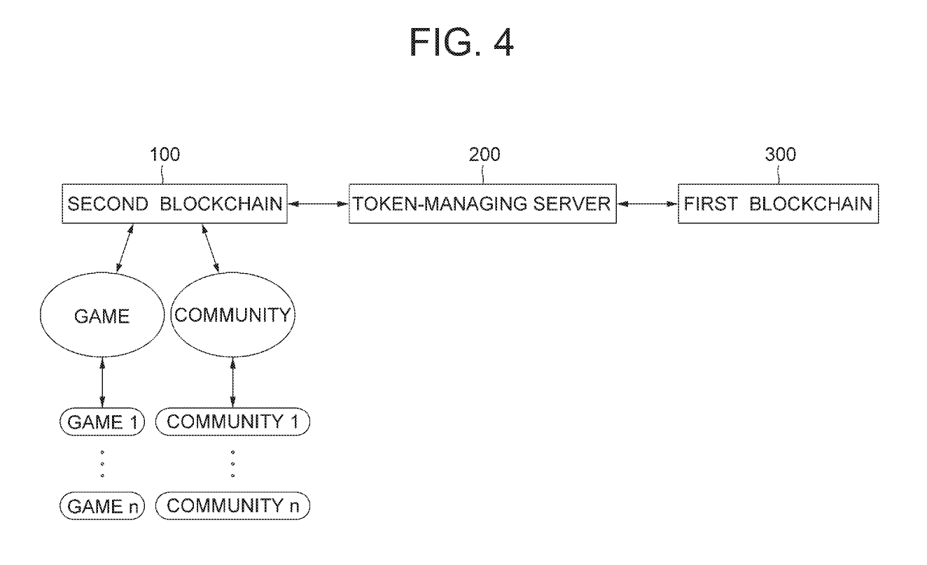

That is, by referring to FIG. 4, the second cryptocurrency may be dependent on the first cryptocurrency, may be spent on each of the services provided by using the second blockchain 100, such as contents like games, community services, etc., and the unit of the second cryptocurrency used in the game may be different from the unit of the second cryptocurrency used in the community. As one example, ten units may be set as a minimal unit of the second cryptocurrency that can be spent in the game, and one hundred units may be set as a minimal unit of the second cryptocurrency that can be spent in the community, so that a single minimal unit of the second cryptocurrency allows ten actions in the game but one hundred actions in the community.

In addition to this, the second cryptocurrency may be set to have different characteristics in each of the sub-blockchain networks.

That is, by referring to FIG. 4, the second cryptocurrency may be dependent on the first cryptocurrency, may be spent on each of the services provided by the sub-blockchain networks in the second blockchain network 100, such as contents like the games, the community services, etc. And only transaction information related to the second cryptocurrency in each game in each of the sub-blockchain networks may be recorded, and property information on traded in-game items in addition to transaction information on trades of the in-game items may be recorded. However, the characteristics of the second cryptocurrency are not limited thereto, and may be expanded to have various characteristics according to the provided contents.

Also, if the specific part of the first cryptocurrency is to be exchanged with the specific part of the second cryptocurrency, the token-managing server 200 may allow an exchange rate between (i) the first cryptocurrency having a market value and (ii) the second cryptocurrency to be either fixed at a preset exchange rate or free-floating according to the market value.

As one example, if the exchange rate is set as free-floating, the first cryptocurrency may have a varying market price due to its trade outside the game or the community, and the second cryptocurrency may have a value fixed to a fiat money, for example, one second cryptocurrency for one cent. Herein, the exchange rate between the first cryptocurrency and the second cryptocurrency may be determined by referring to the market price of the first cryptocurrency per each cycle. Thus, the exchange rate may change per each cycle.

This has advantage in a user service environment. Because the second cryptocurrency which is used in the actual services has a fixed value, the general users can use intuitively and comfortably the second cryptocurrency for the services.

As another example, if the exchange rate is fixed, the value of the second cryptocurrency may vary in connection with the first cryptocurrency. Therefore, the exchange rate between the first cryptocurrency and the second cryptocurrency may be set as a preset exchange rate.

This has advantage of keeping a balance between the first cryptocurrency and the second cryptocurrency without a need for money management in the platform.

Also, the token-managing server 200 may confirm one or more exchange requests for converting from the specific part of the first cryptocurrency to the specific part of the second cryptocurrency made by the specific user, and may determine whether any of the exchange requests violates at least one preset rule. And in response to an exchange request violating the preset rule, the token-managing server 200 may perform warning a requester, raising a system alarm for an abnormal exchange request, canceling an abnormal transaction, etc.

Also, the token-managing server 200 may manage at least one exchange rule and at least one exchange-rate generating rule between the first cryptocurrency and the second cryptocurrency.

For example, the token-managing server 200 may determine at least one of (i) an exchange-rate function between the first cryptocurrency and the second cryptocurrency, (ii) an amount requestable per transaction corresponding to the exchange request, (iii) an amount requestable per user, (iv) an amount requestable during a specific period and the number of exchange requests allowed during the specific period, (v) an exchange-rate policy, (vi) an exchange commission-fee policy for a preset commission fee incurred by the conversion from the second cryptocurrency to the first cryptocurrency, (vii) a calculation policy for calculating a point in time of executing any conversion between the first cryptocurrency and the second cryptocurrency compared to a point in time of the exchange request, and (viii) a limiting policy on a total requested amount and on withdrawal per a total circulation of the second cryptocurrency. Also, when managing the exchange rule and the exchange-rate generating rule between the first cryptocurrency and the second cryptocurrency, the token-managing server 200 may determine various conditions related to the exchange other than the conditions above.

If the specific part of the second cryptocurrency is transferred to the specific user 10 by the processes above, the specific user 10 may spend the specific part of the second cryptocurrency on various services provided by each of the service servers 20 communicating with the second blockchain network 100.

As one example, the specific user 10 may spend the specific part of the second cryptocurrency on the game, or earn the second cryptocurrency by selling in-game items in the game.

It should be noted that operations of the token-managing server 200 transferring the ownership of the specific part of the first cryptocurrency and operations of issuing the specific part of the second cryptocurrency in response to the exchange request for converting from the specific part of the first cryptocurrency to the specific part of the second cryptocurrency may occur in a sequential order, may occur in a different order, and/or may occur concurrently.

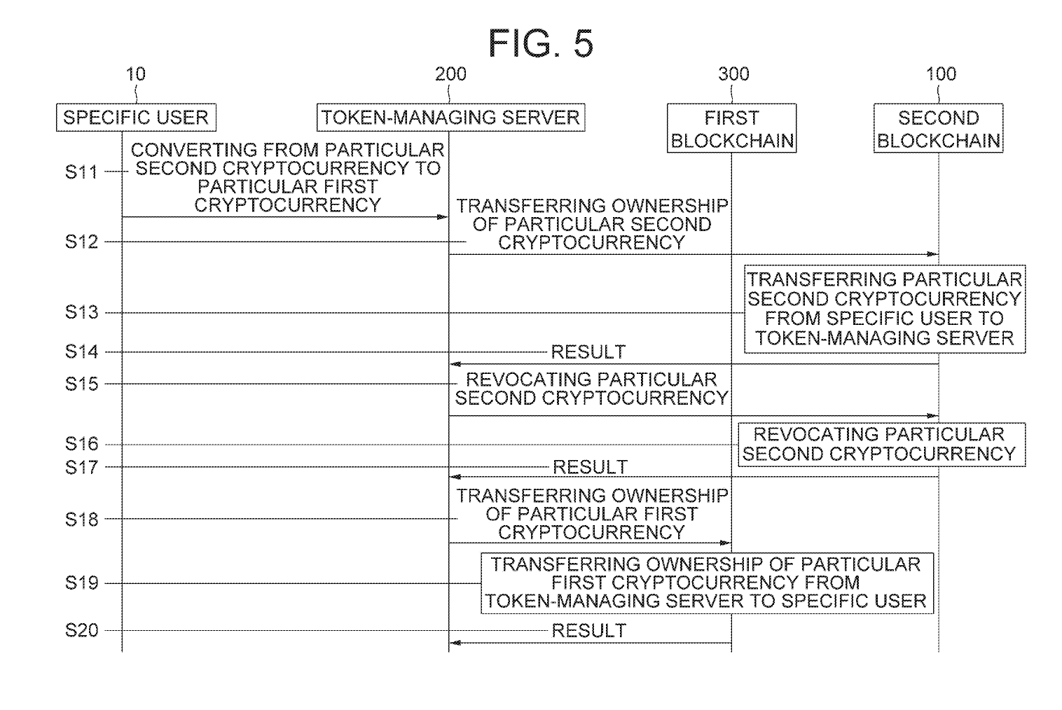

Next, by referring to FIG. 5, a method of converting from the second cryptocurrency to the first cryptocurrency, i.e., a method of exchanging the second cryptocurrency with the first cryptocurrency, is disclosed.

While the specific user 10 uses the services communicating with the second blockchain network 100 with the specific part of the second cryptocurrency exchanged by the method in FIG. 3, the specific user 10 may transmit an exchange request, who owns at least a particular part of the second cryptocurrency which is an amount of the second cryptocurrency requested for conversion, for converting from the particular part of the second cryptocurrency to a particular part of the first cryptocurrency corresponding to the particular part of the second cryptocurrency at a step of S11. Herein, the specific user 10 may not only be a user of the services but also be a service provider.

Then, the token-managing server 200 may instruct the second blockchain network 100 to transfer an ownership of the particular part of the second cryptocurrency from the specific user 10 to the token-managing server 200.

As one example, in response to an exchange request for converting from the particular part of the second cryptocurrency to the particular part of the first cryptocurrency acquired by the communication part 210, the token-managing server 200 may transmit a request for transferring the ownership of the particular part of the second cryptocurrency from the specific user 10 to the token-managing server 200, or instruct the specific user 10 to transfer the particular part of the second cryptocurrency to the token-managing server 200, at a step of S12. Then, in response to a transaction, related to the transfer of the particular part of the second cryptocurrency, created by the token-managing server 200 or the specific user 10, the first blockchain network 300 may transfer the particular part of the second cryptocurrency to the token-managing server 200 at a step of S13, and may transmit a result of the transfer to at least part of the specific user 10 and the token-managing server 200 at a step of S14. That is, the ownership of the particular part of the second cryptocurrency may be transferred from the specific user 10 to the token-managing server 200, which is requested by the specific user, on the second blockchain network 100.

Also, the token-managing server 200 may revocate the particular part of the second cryptocurrency and may instruct the first blockchain network 300 to transfer an ownership of the particular part of the first cryptocurrency, corresponding to the revocated particular part of the second cryptocurrency, from the token-managing server 200 to the specific user 10.

As one example, the token-managing server 200 may transmit a request for revocating the particular part of the second cryptocurrency, whose ownership is transferred to the token-managing server 200 in response to the exchange request, to the second blockchain network 100 at a step of S15. Then, the second blockchain network 100 may revocate the particular part of the second cryptocurrency at a step of S16 as requested by the token-managing server 200, and may transmit a result of the revocation to the token-managing server 200 at a step of S17.

And, the token-managing server 200 may transmit to the first blockchain network 300 a request for transferring the ownership of the particular part of the first cryptocurrency from the token-managing server 200 to the specific user 10, at a step of S18, that is, the token-managing server 200 may generate a transaction of transmitting the particular part of the first cryptocurrency to the specific user 10 among the first cryptocurrency owned by the token-managing server 200 on the first blockchain network 300. Then, the first blockchain network 300 may allow the ownership of the particular part of the first cryptocurrency to be transferred to the specific user 10, at a step of S19, as requested by the token-managing server 200, and may transmit a result of the transfer to at least part of the specific user 10 and the token-managing server 200 at a step of S20.

Herein, if the particular part of the second cryptocurrency is to be exchanged with the particular part of the first cryptocurrency, the token-managing server 200 may allow the exchange rate between (i) the first cryptocurrency having the market value and (ii) the second cryptocurrency dependent on the first cryptocurrency to be either fixed at the preset exchange rate or free-floating according to the market value. A detailed description is omitted as it can be easily understood by referring to the description of FIG. 3.

Also, the token-managing server 200 may confirm one or more exchange requests for converting from the particular part of the second cryptocurrency to the particular part of the first cryptocurrency made by the specific user, and may determine whether any of the exchange requests violates the preset rule. And in response to an exchange request violating the preset rule, the token-managing server 200 may perform warning a requester, raising the system alarm for an abnormal exchange request, canceling an abnormal transaction, etc. As one example, if a balance of the second cryptocurrency owned by the specific user is determined as less than the particular part of the second cryptocurrency, a transaction generated by the exchange request may be canceled.

Also, the token-managing server 200 may manage the exchange rule and the exchange-rate generating rule between the first cryptocurrency and the second cryptocurrency.

Also, the token-managing server 200 may subtract the preset commission fee from the particular part of the second cryptocurrency, in response to the exchange request for converting from the particular part of the second cryptocurrency to the particular part of the first cryptocurrency, may revocate an adjusted particular part of the second cryptocurrency representing an amount of the second cryptocurrency acquired by subtracting the preset commission fee from the particular second part of the second cryptocurrency, and may instruct the first blockchain network 300 to transfer the ownership of an adjusted particular part of the first cryptocurrency, corresponding to the adjusted particular part of the second cryptocurrency, from the token-managing server 200 to the specific user 10.

The subtracted commission fee above may be used for a fund for development of the blockchain ecosystem, and in addition to this, may prevent a user from occupying transactions to the second blockchain network 100 meaninglessly, may block spam attacks economically, and may thwart economically any user or any group with intention of profiting by exchanging between the first cryptocurrency with the market price and the second cryptocurrency with a fixed price.

And, the token-managing server 200 may collect a certain part of the second cryptocurrency corresponding to commission fees, including the preset commission fee, from a first part of the general users into an incentive fund under an ownership of the token-managing server, to thereby manage the incentive fund, and either distribute the certain part of the second cryptocurrency in the incentive fund to a second part of the general users by referring to degrees of contribution of the second part of the general users, or convert from the certain part of the second cryptocurrency to a certain part of the first cryptocurrency, to thereby distribute the certain part of the first cryptocurrency to owners of the certain part of the first cryptocurrency by referring to the degrees of contribution of the second part of the general users.

As one example, the second cryptocurrency may be provided to new users who satisfy at least one criterion, to thereby help the new users to settle, and may be used to provide premium services for VIPs.

Also, a recipient-selection procedure, a payment schedule, the number of recipients, etc. of the incentive fund may be configured according to at least one preset condition. For example, an incentive may be distributed weekly to every address account, i.e., a user, that initiated second-cryptocurrency transactions, by an amount according to each contribution.

And, the distribution may be done by a payment straight to the address account, or by procedures for fun like a weekly lottery or jackpot.

And, in addition to the users of the second blockchain network, owners of the first cryptocurrency circulating in the cryptocurrency market may be provided with the incentive, to thereby increase the market value of the first cryptocurrency, and accordingly, the value of the second cryptocurrency dependent on the first cryptocurrency may be increased.

The present disclosure has an effect of guaranteeing contents and values of digital assets of the user, because the digital assets of the user within digital contents are reverted to the user and ownership and value conversion thereof are guaranteed even if services of a certain content provider within the ecosystem stop or disappear.

The present disclosure has another effect of reducing risk or cost of a transaction of the digital assets of the user by allowing use of the digital contents without a transaction fee via the heterogeneous blockchain networks.

The present disclosure has still another effect of guaranteeing security and transparency of execution and logging of the transaction in the digital contents by using the heterogeneous blockchain networks which are open and cannot be tampered with.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. They have been provided only to help more general understanding of the present invention. It, however, will be understood by those skilled in the art that various changes and modification may be made from the description without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for token management of an exchange between a first cryptocurrency and a second cryptocurrency, wherein a first blockchain network uses the first cryptocurrency and a second blockchain network uses the second cryptocurrency which is dependent on the first cryptocurrency, comprising steps of:
(a) a token-managing server, if an exchange request, of a specific user who owns at least a specific part of the first cryptocurrency which is an amount of the first cryptocurrency requested for conversion, for converting from the first cryptocurrency to the second cryptocurrency is acquired, instructing the first blockchain network to transfer an ownership of the specific part of the first cryptocurrency, from the specific user to the token-managing server and issue a specific part of the second cryptocurrency corresponding to the specific part of the first cryptocurrency and instructing the second blockchain network to transfer an ownership of the issued specific part of the second cryptocurrency from the token-managing server to the specific user; and
(b) the token-managing server, if an exchange request, of the specific user who owns at least a particular part of the second cryptocurrency which is an amount of the second cryptocurrency requested for conversion, for converting from the second cryptocurrency to the first cryptocurrency is acquired, instructing the second blockchain network to transfer an ownership of the particular part of the second cryptocurrency from the specific user to the token-managing server and revocate the particular part of the second cryptocurrency and instructing the first blockchain network to transfer an ownership of a particular part of the first cryptocurrency corresponding to the revocated particular part of the second cryptocurrency from the token-managing server to the specific user.

2. The method of claim 1, wherein, if the second blockchain network is determined as including each of sub-blockchain networks corresponding to each of service servers providing each of services to general users including the specific user by using the second cryptocurrency, the token-managing server monitors transactions, related to the second cryptocurrency, generated in each of the sub-blockchain networks and monitors information on the second cryptocurrency, corresponding to the general users, over all of the sub-blockchain networks.

3. The method of claim 2, wherein the token-managing server allows the second cryptocurrency to have different units of values in each of the sub-blockchain networks.

4. The method of claim 1, wherein the token-managing server allows an exchange rate between (i) the first cryptocurrency having a market value and (ii) the second cryptocurrency to be either fixed at a preset exchange rate or free-floating according to the market value.

5. The method of claim 1, wherein the token-managing server confirms one or more exchange requests for converting from the specific part of the first cryptocurrency to the specific part of the second cryptocurrency made by the specific user or one or more exchange requests for converting from the particular part of the second cryptocurrency to the particular part of the first cryptocurrency made by the specific user, and determines whether any of the exchange requests violates at least one preset rule.

6. The method of claim 1, wherein the token-managing server manages at least one exchange rule and at least one exchange-rate generating rule between the first cryptocurrency and the second cryptocurrency.

7. The method of claim 6, wherein the token-managing server determines at least one of (i) an exchange-rate function between the first cryptocurrency and the second cryptocurrency, (ii) an amount requestable per transaction corresponding to the exchange request, (iii) an amount requestable per user, (iv) an amount requestable during a specific period and the number of exchange requests allowed during the specific period, (v) an exchange-rate policy, (vi) an exchange commission-fee policy for a preset commission fee incurred by the conversion from the second cryptocurrency to the first cryptocurrency, (vii) a calculation policy for calculating a point in time of executing any conversion between the first cryptocurrency and the second cryptocurrency compared to a point in time of the exchange request, and (viii) a limiting policy on a total requested amount and on withdrawal per a total circulation of the second cryptocurrency.

8. The method of claim 1, wherein, at the step of (b), the token-managing server (i) subtracts a preset commission fee from the particular part of the second cryptocurrency, in response to the exchange request for converting from the particular part of the second cryptocurrency to the particular part of the first cryptocurrency, (ii) revocates an adjusted particular part of the second cryptocurrency representing an amount of the second cryptocurrency acquired by subtracting the preset commission fee from the particular second part of the second cryptocurrency, and (iii) instructs the first blockchain network to transfer an ownership of an adjusted particular part of the first cryptocurrency, corresponding to the adjusted particular part of the second cryptocurrency, from the token-managing server to the specific user.

9. The method of claim 8, wherein the token-managing server collects a certain part of the second cryptocurrency corresponding to commission fees, including the preset commission fee, from a first part of general users including the specific user into an incentive fund under an ownership of the token-managing server, to thereby manage the incentive fund, and either distributes the certain part of the second cryptocurrency in the incentive fund to a second part of the general users by referring to degrees of contribution of the second part of the general users, or converts from the certain part of the second cryptocurrency to a certain part of the first cryptocurrency, to thereby distribute the certain part of the first cryptocurrency to owners of the certain part of the first cryptocurrency by referring to the degrees of contribution of the second part of the general users.

10. A method for token management of an exchange between a first cryptocurrency and a second cryptocurrency, wherein a public blockchain network uses the first cryptocurrency having a market value and wherein a private blockchain network is connected with each of service servers providing each of services to at least one specific user by using the second cryptocurrency which is dependent on the first cryptocurrency, comprising steps of:
(a) a token-managing server, if an exchange request, of the specific user who owns at least a specific part of the first cryptocurrency which is an amount of the first cryptocurrency requested for conversion, for converting from the first cryptocurrency to the second cryptocurrency is acquired, instructing the public blockchain network to transfer an ownership of the specific part of the first cryptocurrency, from the specific user to the token-managing server and issue a specific part of the second cryptocurrency corresponding to the specific part of the first cryptocurrency and instructing at least part of the private blockchain network to transfer an ownership of the issued specific part of the second cryptocurrency from the token-managing server to the specific user, to thereby allow the specific user to use each of the services provided by the service servers in connection with at least part of the private blockchain network by using the issued specific part of the second cryptocurrency; and
(b) the token-managing server, if an exchange request, of the specific user who owns at least a particular part of the second cryptocurrency which is an amount of the second cryptocurrency requested for conversion, for converting from the second cryptocurrency to the first cryptocurrency is acquired, instructing at least part of the private blockchain network to transfer an ownership of the particular part of the second cryptocurrency from the specific user to the token-managing server and revocate the particular part of the second cryptocurrency and instructing the public blockchain network to transfer an ownership of a particular part of the first cryptocurrency corresponding to the revocated particular part of the second cryptocurrency from the token-managing server to the specific user.

11. A token-managing server for token management of an exchange between a first cryptocurrency and a second cryptocurrency, wherein a first blockchain network uses the first cryptocurrency and a second blockchain network uses the second cryptocurrency which is dependent on the first cryptocurrency, comprising:
at least one memory that stores instructions; and
at least one processor configured to execute the instructions to perform or support another device to perform processes of: (I) if an exchange request, of a specific user who owns at least a specific part of the first cryptocurrency which is an amount of the first cryptocurrency requested for conversion, for converting from the first cryptocurrency to the second cryptocurrency is acquired, instructing the first blockchain network to transfer an ownership of the specific part of the first cryptocurrency, from the specific user to the token-managing server and issue a specific part of the second cryptocurrency corresponding to the specific part of the first cryptocurrency and instructing the second blockchain network to transfer an ownership of the issued specific part of the second cryptocurrency from the token-managing server to the specific user, and (II) if an exchange request, of the specific user who owns at least a particular part of the second cryptocurrency which is an amount of the second cryptocurrency requested for conversion, for converting from the second cryptocurrency to the first cryptocurrency is acquired, instructing the second blockchain network to transfer an ownership of the particular part of the second cryptocurrency from the specific user to the token-managing server and revocate the particular part of the second cryptocurrency and instructing the first blockchain network to transfer an ownership of a particular part of the first cryptocurrency corresponding to the revocated particular part of the second cryptocurrency from the token-managing server to the specific user.

12. The token-managing server of claim 11, wherein, if the second blockchain network is determined as including each of sub-blockchain networks corresponding to each of service servers providing each of services to general users including the specific user by using the second cryptocurrency, the processor monitors transactions, related to the second cryptocurrency, generated in each of the sub-blockchain networks and monitors information on the second cryptocurrency, corresponding to the general users, over all of the sub-blockchain networks.

13. The token-managing server of claim 12, wherein the processor allows the second cryptocurrency to have different units of values in each of the sub-blockchain networks.

14. The token-managing server of claim 11, wherein the processor allows an exchange rate between (i) the first cryptocurrency having a market value and (ii) the second cryptocurrency to be either fixed at a preset exchange rate or free-floating according to the market value.

15. The token-managing server of claim 11, wherein the processor confirms one or more exchange requests for converting from the specific part of the first cryptocurrency to the specific part of the second cryptocurrency made by the specific user or one or more exchange requests for converting from the particular part of the second cryptocurrency to the particular part of the first cryptocurrency made by the specific user, and determines whether any of the exchange requests violates at least one preset rule.

16. The token-managing server of claim 11, wherein the processor manages at least one exchange rule and at least one exchange-rate generating rule between the first cryptocurrency and the second cryptocurrency.

17. The token-managing server of claim 16, wherein the processor determines at least one of (i) an exchange-rate function between the first cryptocurrency and the second cryptocurrency, (ii) an amount requestable per transaction corresponding to the exchange request, (iii) an amount requestable per user, (iv) an amount requestable during a specific period and the number of exchange requests allowed during the specific period, (v) an exchange-rate policy, (vi) an exchange commission-fee policy for a preset commission fee incurred by the conversion from the second cryptocurrency to the first cryptocurrency, (vii) a calculation policy for calculating a point in time of executing any conversion between the first cryptocurrency and the second cryptocurrency compared to a point in time of the exchange request, and (viii) a limiting policy on a total requested amount and on withdrawal per a total circulation of the second cryptocurrency.

18. The token-managing server of claim 11, wherein, at the process of (II), the processor (i) subtracts a preset commission fee from the particular part of the second cryptocurrency, in response to the exchange request for converting from the particular part of the second cryptocurrency to the particular part of the first cryptocurrency, (ii) revocates an adjusted particular part of the second cryptocurrency representing an amount of the second cryptocurrency acquired by subtracting the preset commission fee from the particular second part of the second cryptocurrency, and (iii) instructs the first blockchain network to transfer an ownership of an adjusted particular part of the first cryptocurrency, corresponding to the adjusted particular part of the second cryptocurrency, from the token-managing server to the specific user.

19. The token-managing server of claim 18, wherein the processor collects a certain part of the second cryptocurrency corresponding to commission fees, including the preset commission fee, from a first part of general users including the specific user into an incentive fund under an ownership of the token-managing server, to thereby manage the incentive fund, and either distributes the certain part of the second cryptocurrency in the incentive fund to a second part of the general users by referring to degrees of contribution of the second part of the general users, or converts from the certain part of the second cryptocurrency to a certain part of the first cryptocurrency, to thereby distribute the certain part of the first cryptocurrency to owners of the certain part of the first cryptocurrency by referring to the degrees of contribution of the second part of the general users.

20. A token-managing server for token management of an exchange between a first cryptocurrency and a second cryptocurrency, wherein a public blockchain network uses the first cryptocurrency having a market value and wherein a private blockchain network is connected with each of service servers providing each of services to at least one specific user by using the second cryptocurrency which is dependent on the first cryptocurrency, comprising:
at least one memory that stores instructions; and
at least one processor configured to execute the instructions to perform or support another device to perform processes of: (I) if an exchange request, of the specific user who owns at least a specific part of the first cryptocurrency which is an amount of the first cryptocurrency requested for conversion, for converting from the first cryptocurrency to the second cryptocurrency is acquired, instructing the public blockchain network to transfer an ownership of the specific part of the first cryptocurrency, from the specific user to the token-managing server and issue a specific part of the second cryptocurrency corresponding to the specific part of the first cryptocurrency and instructing at least part of the private blockchain network to transfer an ownership of the issued specific part of the second cryptocurrency from the token-managing server to the specific user, to thereby allow the specific user to use each of the services provided by the service servers in connection with at least part of the private blockchain network by using the issued specific part of the second cryptocurrency, and (II) if an exchange request, of the specific user who owns at least a particular part of the second cryptocurrency which is an amount of the second cryptocurrency requested for conversion, for converting from the second cryptocurrency to the first cryptocurrency is acquired, instructing at least part of the private blockchain network to transfer an ownership of the particular part of the second cryptocurrency from the specific user to the token-managing server and revocate the particular part of the second cryptocurrency and instructing the public blockchain network to transfer an ownership of a particular part of the first cryptocurrency corresponding to the revocated particular part of the second cryptocurrency from the token-managing server to the specific user.
